(19) United States
(12) Patent Application Publication
(10) Pub. No.: US 2025/0202304 A1
(43) Pub. Date: Jun. 19, 2025

(54) Rotating Electrical Machine and Vehicle Driving Device Equipped With Same

(71) Applicant: Hitachi Astemo, Ltd., Hitachinaka-shi, Ibaraki (JP)

(72) Inventors: Yuri FUJIMA, Tokyo (JP); Masahiro HORI, Tokyo (JP); Takaki ITAYA, Hitachinaka-shi, Ibaraki (JP); Hideaki GOTO, Hitachinaka-shi Ibaraki (JP)

(21) Appl. No.: 18/843,495

(22) PCT Filed: Mar. 8, 2023
(86) PCT No.: PCT/JP2023/008776

§ 371 Date: Sep. 3, 2024

(30) Foreign Application Priority Data
Jun. 15, 2022 (JP) 2022-096714

(51) Int. Cl. H02K 1/32; H02K 1/276; H02K 1/30; H02K 7/00; H02K 7/116; H02K 9/193; H02K 21/14

(52) U.S. Cl. CPC H02K 1/32; H02K 1/276; H02K 1/30; H02K 7/003; H02K 7/116; H02K 9/193; H02K 21/14

(57) ABSTRACT

The purpose of the present invention is to cool stator coils and rotor magnets in accordance with the rotational speed of the rotor. This rotating electrical machine comprises a rotor 110 and a stator 140 that is disposed on the radially outer side of the rotor 110. A rotor shaft 111 is provided on the inner circumferential side of the rotor 110, and a shaft channel 120 is provided in the interior of the rotor shaft. The rotor 110 has: a first channel 131a that extends outward in a radial direction of the rotor shaft 111, and that has a first discharge port that opens outward in the radial direction; and a second channel that extends outward in the radial direction of the rotor shaft 111, extends through the interior of a rotor core 112 in an axial direction, and then extends outward in the radial direction, and that has a second discharge port that opens outward in the radial direction. The first channel 131a and the second channel are connected to a shaft channel 120, and the second discharge port is disposed further outward in the radial direction than the first discharge port.

### TECHNICAL FIELD

The present invention relates to a rotating electrical machine and a vehicle driving device equipped with the rotating electrical machine.

### BACKGROUND ART

As a technique for cooling the rotating electrical machine, there is a technique described in PTLs 1 to 3, for example. In PTL 1, an oil hole is provided in the center portion of a shaft, and a supply hole extending to an outer circumferential side of the shaft penetrates the oil hole. A rotor incorporated in the shaft is provided with a cooling oil passage penetrating in the axial direction and a receiver covering an opening of the cooling oil passage at an end of the cooling oil passage. When the rotor rotates, the receiver receives a lubricating oil discharged from the supply hole to an atmosphere, and the lubricating oil is caused to flow through the cooling oil passage to cool the rotor, and discharged from the cooling oil passage to cool a coil end of a stator.

In PTL 2, an oil passage penetrating a rotor core in the axial direction is provided. One end portion of the rotor core is provided with an end plate in which an oil supply hole communicating with the oil passage and an oil discharge hole causing the oil to be projected into the coil are provided. A cross-sectional area of the oil passage is made larger on the downstream side than on the upstream side of an oil flow. The other end portion of the rotor core is provided with an end plate including an oil discharge hole communicating with the oil passage having an enlarged cross-sectional area. The coil is cooled by the oil discharged from the oil discharge hole, and the rotor is cooled by the oil flowing through the oil passage.

In PTL 3, a hole penetrating radially outward of a rotation shaft and communicating with a shaft channel is provided in the rotation shaft. An end plate is provided at an axial end portion of a rotary core, a groove is provided in the end plate, and a coolant passage is defined by a wall surface of the end plate and an end surface of the rotary core. The coolant passage communicates with a hole of the shaft. A first discharge hole is provided in the middle of the coolant passage, and a second discharge hole is provided at a terminal end of the coolant passage. The oil flowing through the shaft channel, the hole, and the coolant passage is discharged from the first discharge hole and the second discharge hole to cool the coil end.

### CITATION LIST

### Patent Literatures

PTL 1: JP 2019-68622 A
PTL 2: JP 2012-223075 A
PTL 3: JP 2011-142788 A

### SUMMARY OF INVENTION

### Technical Problem

For example, in a rotating electrical machine used for driving a vehicle, when a rotating speed of a rotor is low and a large torque is obtained, a current flowing through a stator coil becomes large and the stator coil generates heat, and therefore it is necessary to cool the stator coil. On the other hand, when the rotating speed of the rotor is high, since an eddy current loss increases in the rotor and heat is generated, it is necessary to cool the rotor in which a magnet is disposed.

According to the technique described in PTL 1, the rotor rotates, the receiver receives the lubricating oil discharged from the supply hole by a centrifugal force, the lubricating oil is caused to flow into the cooling oil passage to cool the rotor, and then the lubricating oil is discharged from the cooling oil passage to cool the coil end of the stator. However, since the lubricating oil discharged from the supply hole is released to the atmosphere, a flow rate of the lubricating oil flowing through the cooling oil passage cannot be increased using the centrifugal force even when the rotating speed of the rotor increases. For this reason, the technique described in PTL 1 involves a problem that the magnet arranged in the rotor cannot be sufficiently cooled according to the increase in the rotating speed of the rotor.

In the technique described in PTL 2, since the cross-sectional area of the oil passage is larger on the downstream side than on the upstream side of the oil flow, the flow rate of the oil flowing through the oil passage cannot be increased using the centrifugal force even when the rotor is opened to the atmosphere and the rotating speed of the rotor increases. For this reason, the technique described in PTL 2 involves a problem that the magnet arranged in the rotor cannot be sufficiently cooled according to the increase in the rotating speed of the rotor.

In the technique described in PTL 3, since a passage through which the coolant flows is not provided in the axial direction of the rotating core, it is difficult to cool the magnet arranged in the rotor.

An object of the present invention is to provide a rotating electrical machine capable of cooling a stator coil and a magnet of a rotor according to a rotating speed of the rotor, and a vehicle driving device including the rotating electrical machine.

### Solution to Problem

In order to achieve the above object, the present invention provides a rotating electrical machine including: a rotor having a magnet disposed in a rotor core; and a stator disposed radially outside of the rotor, wherein the rotor is provided with a rotor shaft on an inner circumferential side of the rotor, and the rotor shaft is provided with, within the rotor shaft, a shaft channel through which a coolant flows, the rotor includes: a first channel extending outside of the rotor shaft in a radial direction, and having a first discharge port opening radially outward; and a second channel extending outside of the rotor shaft in the radial direction, extending along an axial direction inside the rotor core, and then extending outward in the radial direction, and having a second discharge port opening radially outward, the first channel and the second channel are connected to the shaft channel, and the second discharge port is disposed outside from the first discharge port in the radial direction.

### Advantageous Effects of Invention

According to the present invention, it is possible to provide a rotating electrical machine capable of cooling a stator coil and a magnet of a rotor according to a rotating speed of the rotor, and a vehicle driving device including the rotating electrical machine.

### BRIEF DESCRIPTION OF DRAWINGS

FIG. 1 is a schematic configuration diagram of an electric vehicle according to an embodiment of the present invention.

FIG. 2 is a schematic configuration diagram of a system for cooling a vehicle driving device according to the embodiment of the present invention.

FIG. 3 is an exploded perspective view of a rotor 110 as viewed from an opposite-to-load side.

FIG. 4 is an exploded perspective view of the rotor 110 as viewed from a load side.

FIG. 5A is a plan view of a first end plate and a third end plate as viewed from a side facing a second end plate and a fourth end plate.

FIG. 5B is a plan view of the first end plate and the third end plate as viewed from a side facing the rotor core.

FIG. 6 is a sectional view of the rotor taken along a direction orthogonal to an axial direction.

FIG. 7 is a sectional perspective view of the rotor 110 according to a first embodiment of the present invention taken along the axial direction.

FIG. 8 is a sectional view of an upper half of the rotor 110 taken along the axial direction.

FIG. 9 is a diagram illustrating a relationship between flow rates of a first channel and a second channel according to a change in a rotating speed.

FIG. 10 is a sectional view of a rotor according to a second embodiment of the present invention taken along the direction orthogonal to the axial direction.

FIG. 11 is a sectional view of an upper half of the rotor 110 according to a third embodiment of the present invention taken along the axial direction.

FIG. 12 is a sectional perspective view of the rotor 110 according to a fourth embodiment of the present invention taken along the axial direction.

FIG. 13 is a sectional perspective view of the rotor 110 according to a fifth embodiment of the present invention taken along the axial direction.

FIG. 14 is a sectional perspective view of the rotor 110 according to a sixth embodiment of the present invention taken along the axial direction.

### DESCRIPTION OF EMBODIMENTS

Hereinafter, embodiments of the present invention will be described with reference to the accompanying drawings. The same components are denoted by the same reference numerals, and the same description will not be repeated.

Various components of the present invention do not necessarily need to be independent, and various configurations are allowed in which one component is constituted by a plurality of members, a plurality of components are constituted by a single member, a certain component is a part of another component, a part of one component and a part of another component to overlap, and the like.

### First Embodiment

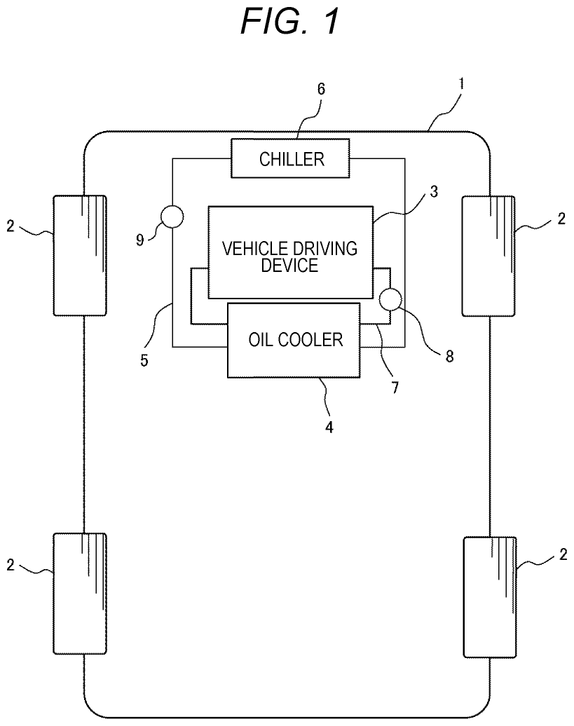

FIG. 1 is a schematic configuration diagram of an electric vehicle according to a first embodiment of the present invention. In FIG. 1, a vehicle driving device 3 for driving wheels 2 is mounted on a vehicle body 1. The vehicle driving device 3 is a driving unit in which devices such as a rotating electrical machine and an inverter are integrated.

To the vehicle driving device 3, an oil cooler 4 is connected via a pipe 7. The pipe 7 is provided with a coolant pump 8 that pumps a first coolant, and causes the coolant to flow to the devices in the vehicle driving device 3 to cool these devices. To the oil cooler 4, a chiller 6 is connected via a pipe 5, and a second coolant flows through the oil cooler 4, the pipe 5, and the chiller 6. In the oil cooler 4, heat exchange is performed, and the heated first coolant is cooled by the second coolant. The second coolant is pumped by a pump 9 provided in the pipe 5 and sent to the chiller 6. In the chiller 6, the second coolant that has been heated is cooled by traveling wind when the vehicle travels. The cooled coolant is again sent to the oil cooler 4.

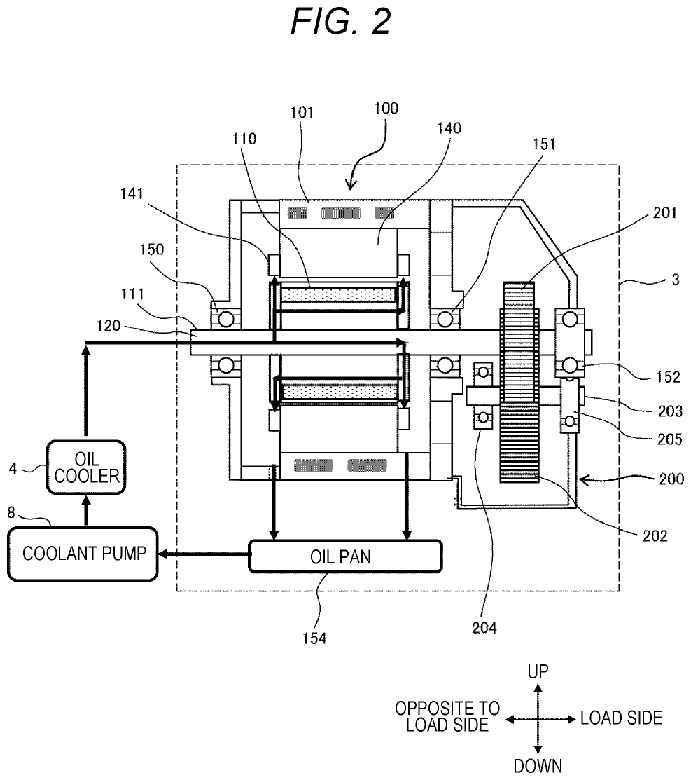

FIG. 2 is a schematic configuration diagram of a system for cooling a vehicle driving device according to the first embodiment of the present invention.

In the drawing, as indicated by arrows, a side toward which the vehicle driving device 3 transmits a driving force is defined as a “load side”, a side opposite to the load side is defined as an “opposite-to-load side”, an upward side is defined as an “upper part/upper side”, and a downward side is defined as a “lower part/lower side”. Further, a direction along the shaft is defined as an “axial direction”, a circumference of the rotor shaft is defined as a “circumferential direction”, a radius direction (radial direction) around the shaft is defined as a “radial direction”, and a direction orthogonal to a horizontal line is defined as a vertical direction.

The vehicle driving device 3 includes a rotating electrical machine 100, a speed reducer 200 that transmits a driving force of the rotating electrical machine 100, and an inverter that is not illustrated.

The rotating electrical machine 100 includes a rotor 110 and a stator 140 disposed on a radially outside of the rotor 110. The rotor 110 and the stator 140 are accommodated in a housing 101.

On an inner circumferential side of the rotor 110, a rotor shaft 111 rotatably supported by bearings 150, 151, and 152 is provided. On the load side of the rotor shaft 111, a driving gear 201 constituting the speed reducer 200, a driven gear 202 that meshes with the driving gear 201 and transmits a driving force to the driving gear 201, a driven gear shaft 203 provided in the driven gear 202, and bearings 204 and 205 that pivotally support the driven gear shaft 203 are provided.

The stator 140 includes a plurality of stator coils 141 inserted into slots defined in a stator core.

An interior of the rotor shaft 111 is hollow, and constitutes a shaft channel 120 through which a coolant flows. The coolant flowing through the shaft channel cools the stator coils 141 and the rotor 110, and then drops into an oil pan 154 disposed under the rotating electrical machine 100. The coolant dropped and collected in the oil pan 154 is pumped by the coolant pump 8 and sent to the oil cooler 4 and the shaft channel 120. Then, the coolant drops into the oil pan 154 again after the stator coils 141 and the rotor 110 are cooled. In the present embodiment, the coolant is circulated in this manner and cools the stator coils 141 and the rotor 110.

Next, a detailed structure for cooling the stator coils 141 and the rotor 110 will be described.

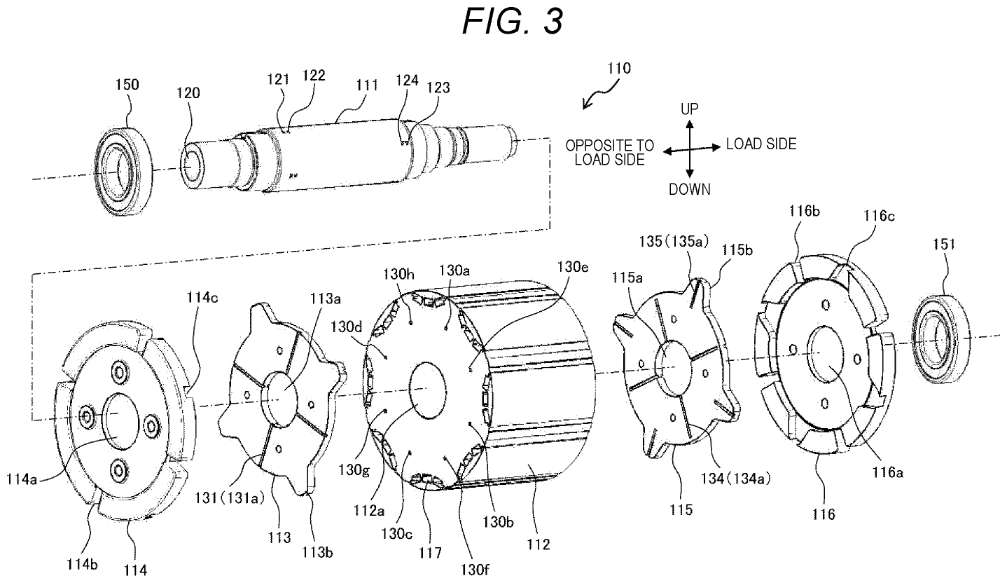

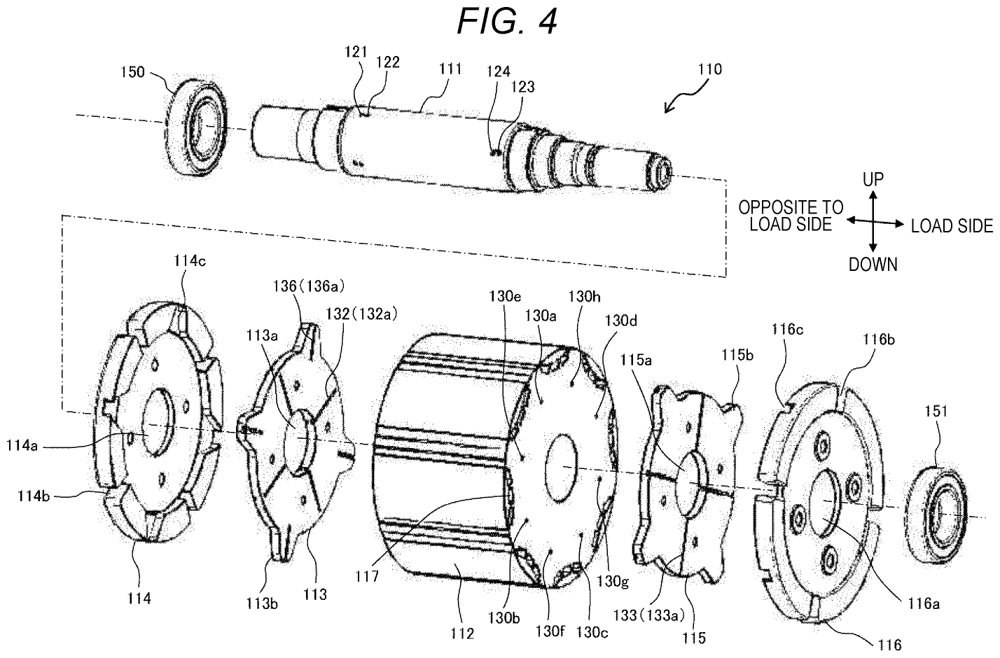

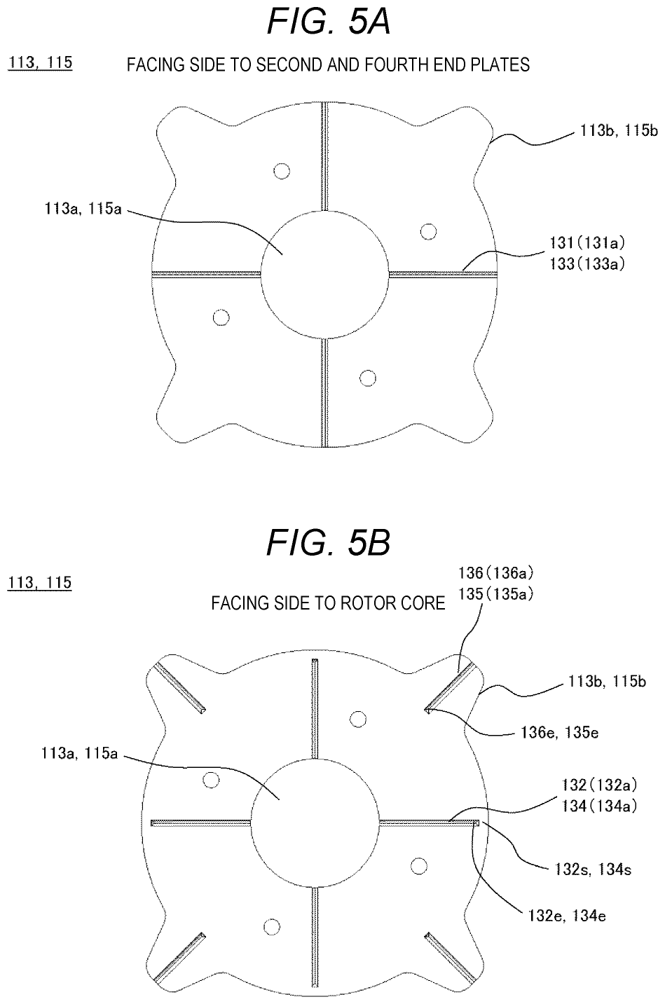

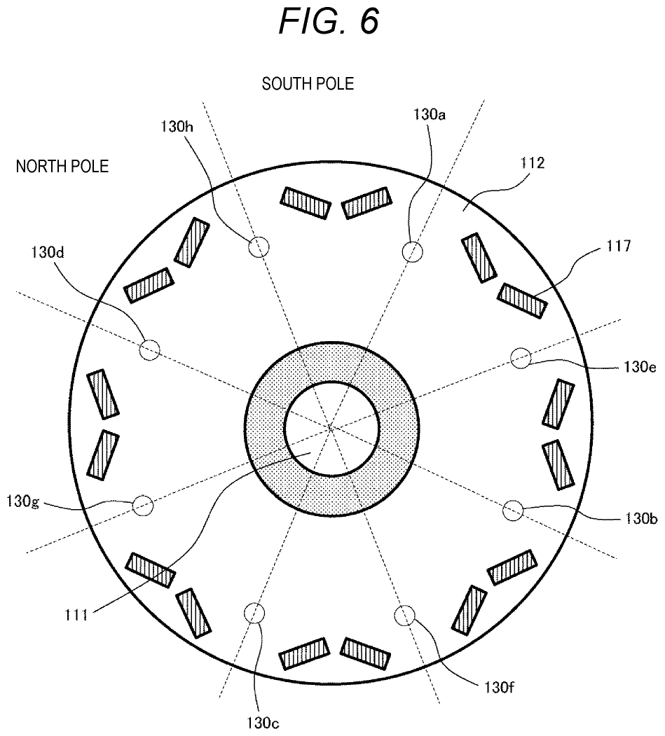

FIG. 3 is an exploded perspective view of the rotor 110 as viewed from the opposite-to-load side. FIG. 4 is an exploded perspective view of the rotor 110 as viewed from the load side. FIG. 5A is a plan view of a first end plate and a third end plate as viewed from a side facing a second end plate and a fourth end plate. FIG. 5B is a plan view of the first end plate and the third end plate as viewed from a side facing the rotor core. FIG. 6 is a sectional view of the rotor taken along a direction orthogonal to the axial direction.

The rotor 110 includes a rotor core 112 provided by laminating a plurality of steel plates, a first end plate 113 disposed at one axial end portion (opposite-to-load side) of the rotor core 112, a second end plate 114 disposed outside of the first end plate 113 on one side in the axial direction (opposite-to-load side), a third end plate 115 disposed at the other axial end portion (load side) of the rotor core 112, and a fourth end plate 116 disposed outside of the third end plate 115 on the other side in the axial direction (opposite-to-load side). The first end plate 113 is disposed so as to be sandwiched between the second end plate 114 and the rotor core 112, and the third end plate 115 is disposed so as to be sandwiched between the fourth end plate 116 and the rotor core 112.

An outer peripheral surface of the rotor shaft 111 is provided with a first shaft channel hole 121 communicating with the shaft channel 120, a second shaft channel hole 122 communicating with the shaft channel 120 and arranged adjacent to the first shaft channel hole 121, a third shaft channel hole 123 communicating with the shaft channel 120, and a fourth shaft channel hole 124 communicating with the shaft channel 120 and arranged adjacent to the third shaft channel hole 123.

The first shaft channel hole 121 and the second shaft channel hole 122 are arranged at the same position in the circumferential direction of the rotor shaft 111, and the third shaft channel hole 123 and the fourth shaft channel hole 124 are arranged at the same position in the circumferential direction of the rotor shaft 111. The first shaft channel hole 121 (the second shaft channel hole 122) and the third shaft channel hole 123 (the fourth shaft channel hole 124) are arranged with shift in the circumferential direction of the rotor shaft 111. Further, a plurality of the first shaft channel holes 121 to the fourth shaft channel holes 124 are provided in the circumferential direction of the rotor shaft 111.

An insertion hole 113a that penetrates in the axial direction and into which the rotor shaft 111 is inserted is provided in the central portion of the first end plate 113.

On an outer surface of the first end plate 113 (a side of the second end plate 114), a plurality of first grooves 131 extending radially outward from the insertion hole 113a in a radial manner are provided.

On an inner surface of the first end plate 113 (a side of the rotor core 112), a plurality of second grooves 132 extending radially outward from the insertion hole 113a in a radial manner are provided.

The first end plate 113 is provided with a plurality of protruding portions 113b protruding radially outward. On surfaces of the protruding portions 113b of the inner surface of the first end plate 113 (a side of the rotor core 112), a plurality of sixth grooves 136 extending radially outward in a radial manner are provided.

The first end plate 113 is disposed at a position overlapping the first shaft channel hole 121 and the second shaft channel hole 122 provided in the rotor shaft 111. Further, the first grooves 131 are caused to communicate with the first shaft channel hole 121, and the second grooves 132 are caused to communicate with the second shaft channel hole 122.

When the first end plate 113 is brought into contact with the second end plate 114, each of the first grooves 131 is covered, and a first channel 131a through which the coolant flows is provided. That is, the first groove 131 is defined by being sandwiched between the first end plate 113 and the second end plate 114. Radially, the first channel 131a is provided so as to penetrate from the insertion hole 113a to outside in the radial direction.

When the first end plate 113 is brought into contact with the rotor core 112, each of the second grooves 132 is covered, and an opposite-to-load-side second channel 132a (second channel) through which the coolant flows is provided. When the first end plate 113 is brought into contact with the rotor core 112, each of the sixth grooves 136 is covered, and an opposite-to-load-side fourth channel 136a (fourth channel) through which the coolant flows is provided. That is, the opposite-to-load-side second channel 132a, which is a part of the second channel, and the opposite-to-load-side fourth channel 136a, which is a part of the fourth channel, are defined by being sandwiched between the first end plate 113 and the rotor core 112.

A radially inside part of the opposite-to-load-side second channel 132a (second channel) is penetrated to the insertion hole 113a, but a radially outside part is dammed by a damming portion 132s (FIG. 5B). A radially outside end portion 132e of the opposite-to-load-side second channel 132a (second channel) is connected to a rotor core channel 130. In addition, a radially outside part of the opposite-to-load-side fourth channel 136a (fourth channel) is penetrated, but a radially inside part is dammed. A radially inside end portion 136e of the opposite-to-load-side fourth channel 136a (fourth channel) is connected to the rotor core channel 130.

In the second end plate 114, an insertion hole 114a into which the rotor shaft 111 is inserted, a notch 114b serving as a first discharge port of the first channel 131a, and a fitting notch 114c serving as a fourth discharge port and in which protruding portion 113b is fitted are provided.

In the present embodiment, the first channel 131a, the opposite-to-load-side second channel 132a (second channel), and the opposite-to-load-side fourth channel 136a (fourth channel) are provided by combining the first end plate 113, the second end plate 114, and the rotor core 112. By combining these with the rotor shaft 111, the first channel 131a and the first shaft channel hole 121 communicate with each other, and the opposite-to-load-side second channel 132a (second channel) and the second shaft channel hole 122 communicate with each other.

An insertion hole 115a that penetrates in the axial direction and into which the rotor shaft 111 is inserted is provided in the central portion of the third end plate 115.

On an outer surface of the third end plate 115 (a side of the fourth end plate 116), a plurality of third grooves 133 extending radially outward from the insertion hole 115a in a radial manner are provided.

On an inner surface of the third end plate 115 (a side of the rotor core 112), a plurality of fourth grooves 134 extending radially outward from the insertion hole 115a in a radial manner are provided.

The third end plate 115 is provided with a plurality of protruding portions 115b protruding radially outward. On surfaces of the protruding portions 115b of the inner surface of the third end plate 115 (a side of the rotor core 112), a plurality of fifth grooves 135 extending radially outward in a radial manner are provided.

The third end plate 115 is disposed at a position overlapping the third shaft channel hole 123 and the fourth shaft channel hole 124 provided in the rotor shaft 111. Further, the third grooves 133 are caused to communicate with the third shaft channel hole 123, and the fourth grooves 134 are caused to communicate with the fourth shaft channel hole 124.

When the third end plate 115 is brought into contact with the fourth end plate 116, each of the third grooves 133 is covered, and a third channel 133a through which the coolant flows is provided. That is, the third groove 133 is provided by being sandwiched between the third end plate 115 and the fourth end plate 116. The third channel 133a is defined so as to penetrate radially outward from the insertion hole 113a in the radial direction.

When the third end plate 115 is brought into contact with the rotor core 112, each of the fourth grooves 134 is covered, and a load-side fourth channel 134a (fourth channel) through which the coolant flows is provided. When the third end plate 115 is brought into contact with the rotor core 112, each of the fifth grooves 135 is covered, and a load-side second channel 135a (second channel) through which the coolant flows is provided. That is, the load-side fourth channel 134a, which is a part of the fourth channel, and the load-side second channel 135a, which is a part of the second channel, are defined by being sandwiched between the third end plate 115 and the rotor core 112.

A radially inside part of the load-side fourth channel 134a (fourth channel) is penetrated to the insertion hole 115a, but a radially outside part is dammed by a damming portion 134s (FIG. 5B). A radially outside end portion 134e of the load-side fourth channel 134a (second channel) is connected to the rotor core channel 130. In addition, a radially outside part of the opposite-to-load-side second channel 135a (second channel) is penetrated, but a radially inside part is dammed. A radially inside end portion 135e of the load-side second channel 135a (second channel) is connected to the rotor core channel 130.

In the fourth end plate 116, an insertion hole 116a into which the rotor shaft 111 is inserted, a notch 116b serving as a third discharge port of the third channel 133a, and a fitting notch 116c serving as a second discharge port and in which protruding portion 115b is fitted are provided.

In the present embodiment, the third channel 133a and the load-side fourth channel 134a (fourth channel) are provided by combining the third end plate 115, the fourth end plate 116, and the rotor core 112. By combining these with the rotor shaft 111, the third channel 133a and the third shaft channel hole 123 communicate with each other, and the load-side fourth channel 134a (fourth channel) and the fourth shaft channel hole 124 communicate with each other.

Further, in the present embodiment, the connection portions of the first channel and the second channel with the shaft channel 120 are located on one side of the rotor shaft 111, and the connection portions of the third channel and the fourth channel with the shaft channel 120 are located on the other side of the rotor shaft 111.

Next, the rotor core 112 will be described with reference to FIGS. 3 to 6. The rotor core 112 is provided with a plurality of permanent magnets (magnets) 117. The permanent magnets 117 are disposed such that N poles and S poles are alternately arranged in the circumferential direction. Each of the permanent magnets 117 disposed on each of the poles is divided.

In the rotor core 112, an insertion hole 112a penetrating in the axial direction into which the rotor shaft 111 is inserted, and a plurality of the rotor core channels 130 (the rotor core channels 130a to 130h) penetrating in the axial direction and constituting a part of the second channel and the fourth channel through which the coolant flows are provided. The plurality of the rotor core channels 130a to 130h are arranged so as to maintain magnetic pole symmetry or magnetic pole pair symmetry. In the present embodiment, the plurality of the rotor core channels 130a to 130h are arranged at intervals of 45° in the circumferential direction. According to the present embodiment, since the plurality of the rotor core channels 130a to 130h constituting the second channel and the fourth channel are arranged so as to maintain the magnetic pole symmetry or the magnetic pole pair symmetry, it is possible to suppress a difference in motor characteristics between powering and regeneration.

Among the plurality of rotor core channels 130, each of the rotor core channels 130a to 130d communicates with the opposite-to-load-side second channel 132a (second channel) at a position of the radially outside end portion 132e defined in the first end plate 113, and each of the rotor core channels 130e to 130h communicates with the opposite-to-load-side fourth channel 136a (fourth channel) at a position of the radially inside end portion 136e defined in the first end plate 113. That is, the rotor core channels 130a to 130d are the second channels, and the rotor core channels 130e to 130h are the fourth channels.

Among the plurality of rotor core channels 130, each of the rotor core channels 130a to 130d communicates with the load-side second channel 135a (second channel) at a position of the radially inside end portion 135e defined in the third end plate 115, and each of the rotor core channels 130e to 130h communicates with the load-side fourth channel 134a (fourth channel) at a position of the radially outside end portion 134e defined in the third end plate 115.

The second channels of the present embodiment extend outside of the rotor shaft 111 in the radial direction to be connected to the respective rotor core channels 130a to 130d by the opposite-to-load-side second channel 132a, extend along the axial direction inside the rotor core 112 by the respective rotor core channels 130a to 130d, and then extend outward in the radial direction to be connected to the load-side second channel 135a, and each include a second discharge port opening radially.

Similarly, the fourth channels of the present embodiment extend outside of the rotor shaft 111 in the radial direction to be connected to the respective rotor core channels 130e to 130h by the load-side fourth channel 134a, extend along the axial direction inside the rotor core 112 by the respective rotor core channels 130e to 130h, and then extend outward in the radial direction to be connected to the opposite-to-load-side fourth channel 136a, and each include a fourth discharge port opening radially.

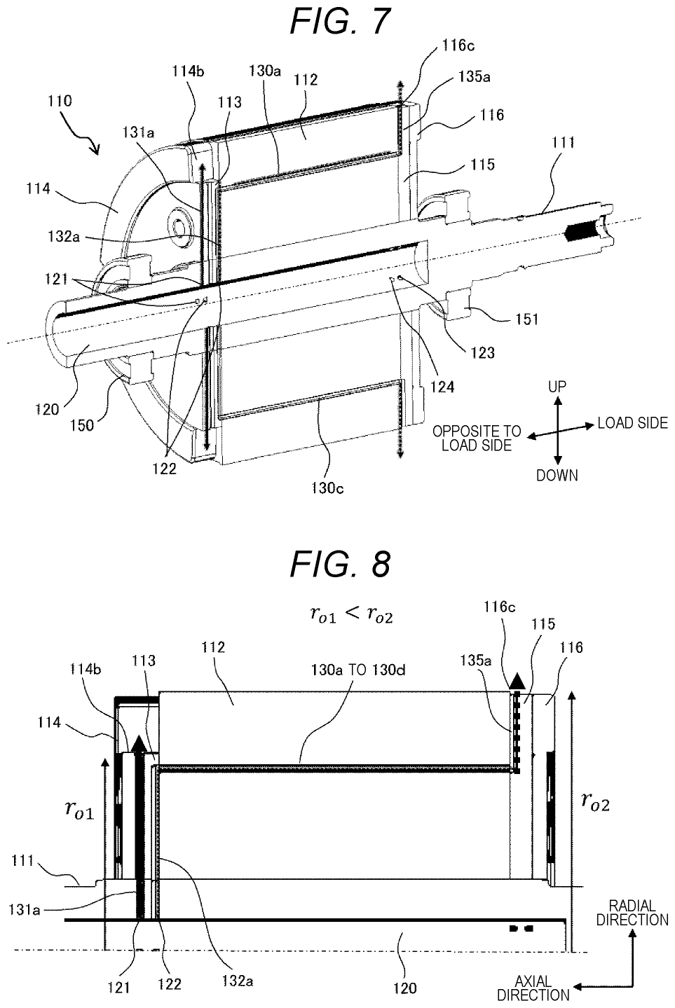

Next, a flow of the coolant in the rotor 110 will be described. FIG. 7 is a sectional perspective view of the rotor 110 according to the first embodiment of the present invention taken along the axial direction. FIG. 8 is a sectional view of an upper half of the rotor 110 taken along the axial direction.

The rotor shaft 111 has an opening at one end in the axial direction (opposite-to-load side), and the other end (load side) is solid. The coolant pump 8 is connected to the opening at the one end of the rotor shaft 111 via the oil cooler 4 (FIG. 2). When the rotor 110 rotates, a part of the coolant flowing into the shaft channel 120 is discharged from the first shaft channel hole 121 and the second shaft channel hole 122.

The coolant discharged radially outward from the first shaft channel hole 121 is passed through the first channel 131a and discharged from the notch 114b (first discharge port). The coolant discharged from the notch 114b bumps the stator coils 141 and cools the stator coils 141.

The coolant discharged radially outward from the second shaft channel hole 122 is passed through the opposite-to-load-side second channel 132a defining the second channel, the rotor core channels 130 (130a, 130c, 130e, and 130g), and the load-side second channel 135a, and is discharged from the fitting notch 116c (second discharge port). The coolant discharged from the fitting notch 116c bumps the stator coils 141 and cools the stator coils 141. In addition, since the coolant flowing through the second channel flows within the rotor core 112, the coolant cools the permanent magnets 117 disposed on the rotor core 112.

Similarly, the coolant discharged radially outward from the third shaft channel hole 123 is passed through the third channel 133a and is discharged from the notch 116b (third discharge port). The coolant discharged from the notch 116b bumps the stator coils 141 and cools the stator coils 141.

The coolant discharged radially outward from the fourth shaft channel hole 124 is passed through the load-side fourth channel 134a defining the fourth channel, the rotor core channel 130 (130b, 130d, 130f, and 130h), and the opposite-to-load-side fourth channel 136a, and is discharged from the fitting notch 114c (fourth discharge port). The coolant discharged from the fitting notch 114c bumps the stator coils 141 and cools the stator coils 141. In addition, since the coolant flowing through the fourth channel flows within the rotor core 112, the coolant cools the permanent magnets 117 disposed on the rotor core 112.

The rotor core channels are disposed such that flows of the rotor core channels 130a to 130d defining the second channels and flows of the rotor core channels 130e to 130h defining the fourth channels are opposed to each other in the axial direction, and alternately arranged in the circumferential direction.

The first channels and the second channels, and the third channels and the fourth channels are respectively arranged at equal intervals (four each) in the circumferential direction. In addition, numbers of the first channels and the second channels on one side and the other side in the axial direction are the same, and numbers of the third channels and the fourth channels on one side and the other side in the axial direction are the same.

Furthermore, in the present embodiment, the first channel and the third channel are arranged with shift by 45° in the circumferential direction so as not to overlap each other when viewed in the axial direction. Similarly, the second channel and the fourth channel are arranged with shift by 45° in the circumferential direction so as not to overlap each other when viewed in the axial direction. With this arrangement, a weight balance in the circumferential direction of the rotor can be made uniform, and eccentricity during rotation of the rotor can be suppressed.

A rotating speed of the rotating electrical machine used for driving a vehicle or the like changes according to a load. Since a large motor torque is required at the time of low-speed rotation, a current flowing through the stator coils increases, and a calorific value of the stator coils increases. On the other hand, during high-speed rotation, an eddy current loss increases, and temperature of the permanent magnets increases. That is, it is preferable that the rotating electrical machine mainly cools the stator coils during the low-speed rotation, and mainly cools the permanent magnets during the high-speed rotation.

In the present embodiment, the fitting notch 116c (second discharge port) serving as the discharge port of the second channel is disposed outside from the notch 114b (first discharge port) serving as the discharge port of the first channel in the radial direction.

That is, a discharge position γ02 of the fitting notch 116c (second discharge port) is larger than a discharge position γ01 of the notch 114b (first discharge port) (γ02>γ01).

In the present embodiment, since the fitting notch 116c (second discharge port) is disposed outside from the notch 114b (first discharge port) in the radial direction, a channel resistance of the second channel is larger than that of the first channel. When the rotor 110 is rotated, the channels are filled with the coolant, and the coolant is discharged from the notch 114b (first discharge port) and the fitting notch 116c (second discharge port). However, when the rotating speed of the rotor 110 is low (low-speed rotation), a centrifugal force due to the rotation of the rotor 110 is small, and an amount of the coolant discharged from the notch 114b (first discharge port) having a small channel resistance increases.

On the other hand, when the rotating speed of the rotor 110 is high (high-speed rotation), the centrifugal force acting on the coolant in the fitting notch 116c (second discharge port) disposed outside from the notch 114b (first discharge port) in the radial direction increases. Therefore, the coolant flowing through the second channels (the opposite-to-load-side second channel 132a, the rotor core channels 130a to 130e, and the load-side second channel 135a) increases as compared to the coolant flowing through the first channel.

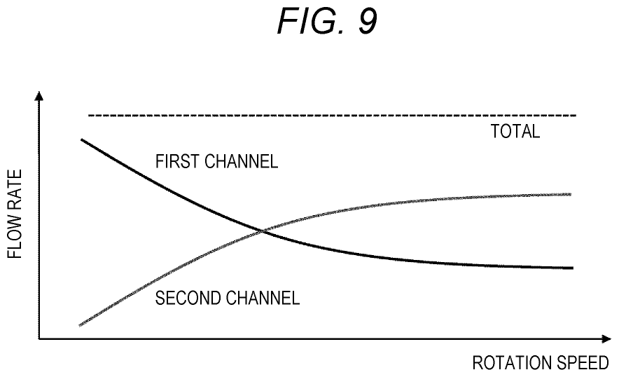

FIG. 9 is a diagram illustrating a relationship between flow rates of the first channel and the second channel according to a change in the rotating speed. In FIG. 9, a total of a discharge amount from the first channel and a discharge amount from the second channel is a total discharge amount. As illustrated in FIG. 9, as the rotating speed increases, the discharge amount from the first channel decreases. On the other hand, when the rotating speed increases, the discharge amount from the second channel increases. As described above, in the present embodiment, the discharge amounts from the first channel and the second channel change according to the rotating speed.

According to the present embodiment, when the rotating speed of the rotor is low, it is possible to mainly cool the stator coils in which the amount of heat generation increases by increasing the amount of the coolant flowing through the first channel, and when the rotating speed of the rotor is high, it is possible to mainly cool the permanent magnets in which the temperature rises due to an increase in an eddy current loss by increasing the amount of the coolant flowing through the second channel.

Further, according to the present embodiment, since the first channel and the second channel independently communicate with the shaft channel 120, a centrifugal pump effect due to the centrifugal force acting on the coolant in the second channel acts only on the second channel, and the flow rate increase in the second channel due to the centrifugal pump effect during high-speed rotation can be further improved.

Although not described, a relationship between the notch (third discharge port) 116b and the fitting notch (fourth discharge port) 114c is the same as the relationship between the notch 114b (first discharge port) and the fitting notch 116c (second discharge port).

### Second Embodiment

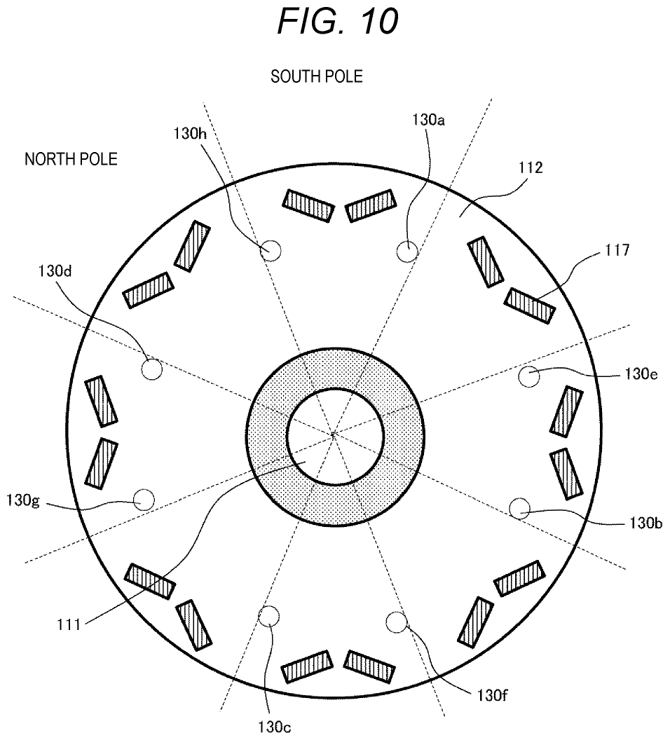

A second embodiment of the present invention will be described with reference to FIG. 10. Configurations common to those in the first embodiment are denoted by the same reference numerals, and a detailed description thereof will be omitted. FIG. 10 is a sectional view of the rotor according to the second embodiment of the present invention taken along a direction orthogonal to the axial direction.

In the first embodiment, the plurality of the rotor core channels 130a to 130h are arranged so as to maintain the magnetic pole symmetry or the magnetic pole pair symmetry. In the second embodiment, the plurality of the rotor core channels 130a to 130h are arranged so as not to maintain the magnetic pole symmetry or the magnetic pole pair symmetry.

According to the present embodiment, since the rotor core channels 130a to 130d constituting the second channels and the rotor core channels 130e to 130h constituting the fourth channels are provided so as not to maintain the magnetic pole symmetry or the magnetic pole pair symmetry, an amplitude of an annular vibration mode corresponding to the symmetry of a shape of the rotor can be reduced, and vibrations and noises can be suppressed.

### Third Embodiment

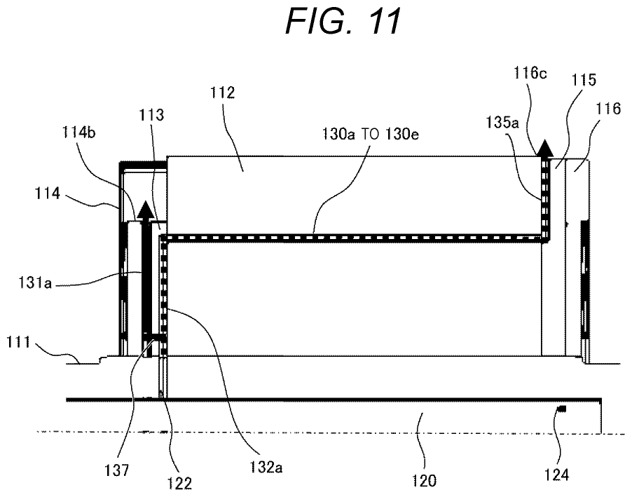

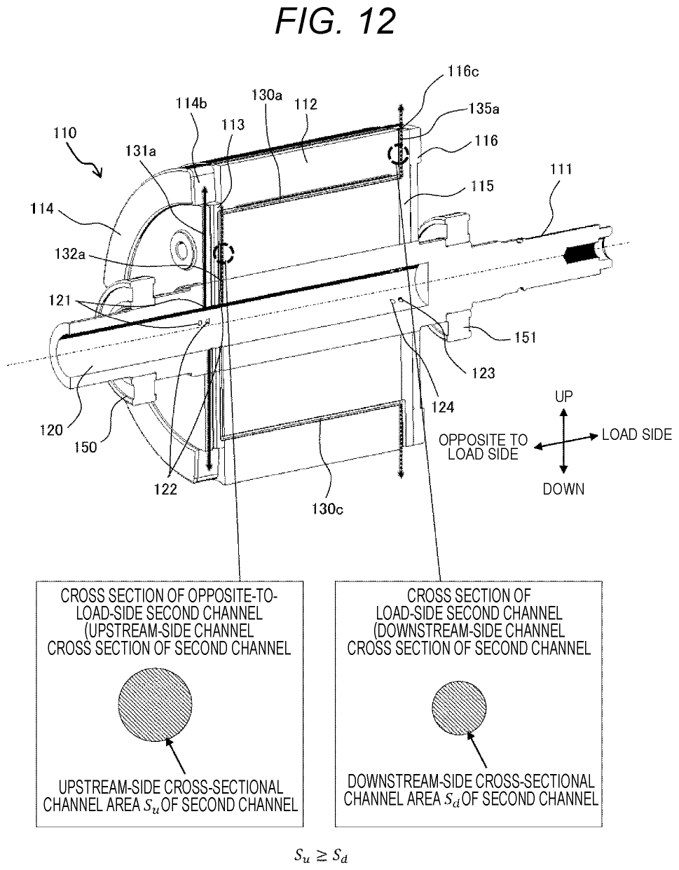

A third embodiment of the present invention will be described with reference to FIG. 11. Configurations common to those in the first embodiment are denoted by the same reference numerals, and a detailed description thereof will be omitted. FIG. 11 is a sectional view of an upper half of the rotor 110 according to the third embodiment of the present invention taken along the axial direction.

In the first embodiment, the first channel and the opposite-to-load-side second channel 132a (second channel) are independently communicated with the shaft channel 120. In the third embodiment, the first channel and the opposite-to-load-side second channel 132a (second channel) share a connection portion to the shaft channel 120.

The outer peripheral surface of the rotor shaft 111 is provided with a second shaft channel hole 122 communicating with the shaft channel 120, and a fourth shaft channel hole 124 communicating with the shaft channel 120. The opposite-to-load-side second channel 132a (second channel) and the second shaft channel hole 122 communicate with each other.

One end of a branch channel 137 is connected to the opposite-to-load-side second channel 132a (second channel), and the other end of the branch channel 137 is connected to the first channel 131a.

The coolant discharged from the second shaft channel hole 122 flows through the opposite-to-load-side second channel 132a (second channel), is branched by the branch channel 137 to flow into the first channel 131a, and flows through the first channel 131a. The subsequent flow of the coolant is the same as that in the first embodiment, and thus description thereof is omitted.

According to the present embodiment, since the first channel and the second channel share the communication portion to the shaft channel, a channel structure can be simplified.

Although not described, the third channel and the fourth channel to the shaft channel similarly share a communication portion to the shaft channel.

### Fourth Embodiment

A fourth embodiment of the present invention will be described with reference to FIG. 12. Configurations common to those in the first embodiment are denoted by the same reference numerals, and a detailed description thereof will be omitted. FIG. 12 is a sectional perspective view of the rotor 110 according to the fourth embodiment of the present invention taken along the axial direction.

In the fourth embodiment, cross-sectional channel areas of the opposite-to-load-side second channel 132a and the load-side second channel 135a defining the second channels are different from each other. The cross-sectional channel area (upstream-side cross-sectional channel area Sᵤ) of the opposite-to-load-side second channel 132a located on the upstream side of the second channel is equal to or larger than the cross-sectional channel area (downstream-side cross-sectional channel area S_{d}) of the load-side second channel 135a located on the downstream side.

According to the present embodiment, by making the cross-sectional channel area smaller on the downstream side than on the upstream side, it is possible to suppress a decrease in the pressure difference generated by the centrifugal force acting on the coolant due to the entrance of the atmosphere from the discharge port into the channel, and thus, it is possible to further improve the flow rate increasing effect of the second channel at the time of high-speed rotation.

In the present embodiment, the second channel has been described, but the first channel, the third channel, and the fourth channel may be configured in the same manner.

### Fifth Embodiment

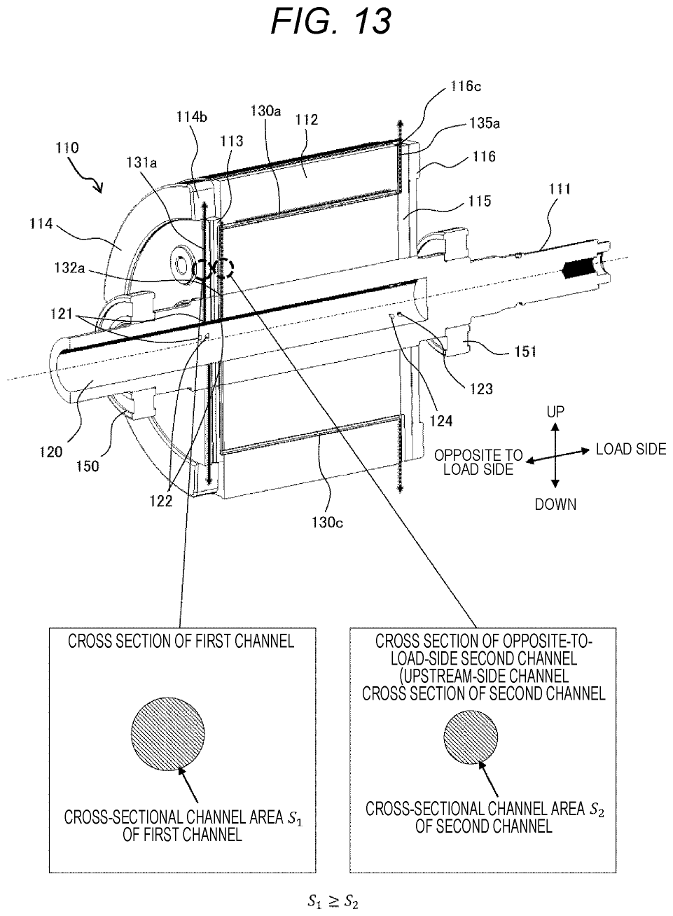

A fifth embodiment of the present invention will be described with reference to FIG. 13. Configurations common to those in the first embodiment are denoted by the same reference numerals, and a detailed description thereof will be omitted. FIG. 13 is a sectional perspective view of the rotor 110 according to the fifth embodiment of the present invention taken along the axial direction.

In the fifth embodiment, cross-sectional channel areas of the first channel 131a and the opposite-to-load-side second channel 132a defining the second channel are different from each other. A cross-sectional channel area S₁ of the first channel 131a is equal to or larger than the cross-sectional channel area (a cross-sectional area S₂ of the second channel) of the opposite-to-load-side second channel 132a upstream of the second channel.

According to the present embodiment, by setting the cross-sectional channel area of the first channel to be equal to or larger than the cross-sectional channel area of the second channel, a channel resistance of the first channel can be reduced, and a flow rate ratio of the first channel during the low-speed rotation can be increased. Therefore, the cooling performance of the stator coil during low-speed rotation can be improved.

### Sixth Embodiment

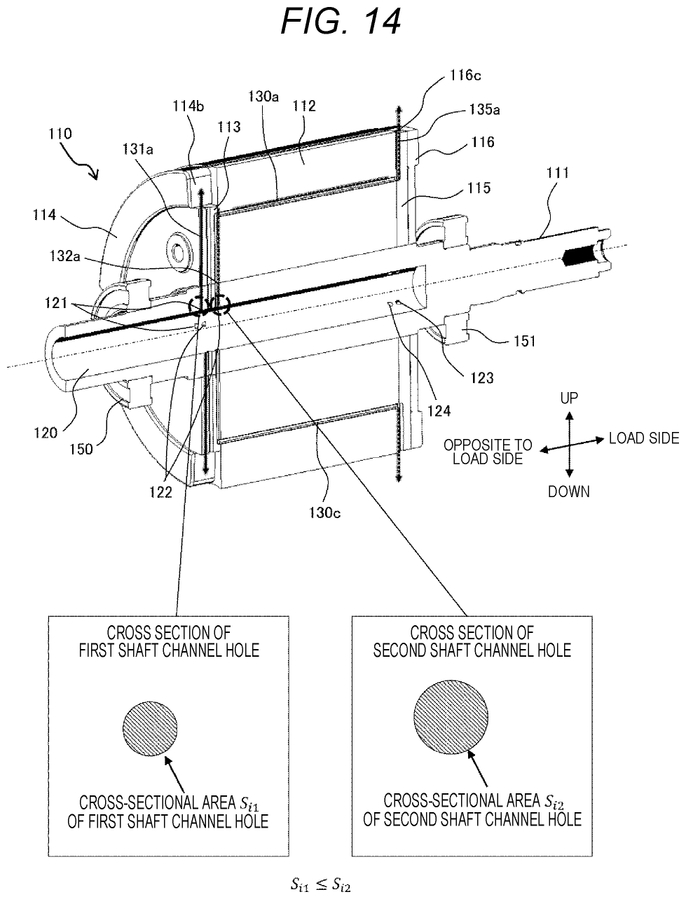

A sixth embodiment of the present invention will be described with reference to FIG. 14. Configurations common to those in the first embodiment are denoted by the same reference numerals, and a detailed description thereof will be omitted. FIG. 14 is a sectional perspective view of the rotor 110 according to the sixth embodiment of the present invention taken along the axial direction.

In the sixth embodiment, cross-sectional areas of the first shaft channel hole 121 and the second shaft channel hole 122 are different from each other. The cross-sectional area Sᵢ₁ of the first shaft channel hole 121 is equal to or smaller than the cross-sectional area Sᵢ₂ of the second shaft channel hole 122.

According to the present embodiment, by making a cross-sectional area of an inlet of the first channel be smaller than a cross-sectional area of an inlet of the second channel, an inlet pressure loss, which is a main pressure loss during high-speed rotation, to be smaller in the second channel than in the first channel. Therefore, a flow rate ratio of the second channel during the high-speed rotation can be increased.

Note that the present invention is not limited to the above-described embodiments, and includes various modifications.

The above-described embodiments have been described in detail in order to describe the present invention in an easy-to-understand manner, and are not necessarily intended to limit to those having all of the described configurations.

### REFERENCE SIGNS LIST

1 vehicle body
2 wheel
3 vehicle driving device
4 oil cooler
5 pipe
6 chiller
7 pipe
8 coolant pump
100 rotating electrical machine
101 housing
110 rotor
111 rotor shaft
112 rotor core
113 first end plate
113a insertion hole
114 second end plate
114a insertion hole
114b notch (first discharge port)
114c fitting notch (fourth discharge port)
115 third end plate
115a insertion hole
115b protruding portion
116 fourth end plate
116a insertion hole
116b notch (third discharge port)
116c fitting notch (second discharge port)
117 permanent magnet
120 shaft channel
121 first shaft channel hole
122 second shaft channel hole
123 third shaft channel hole
124 fourth shaft channel hole
130, 130a to 130h rotor core channel
131 first groove
131a first channel
132 second groove
132a opposite-to-load-side second channel (second channel)
132s damming portion
132e radially outside end portion
133 third groove
133a third channel
134 fourth groove
134a load-side fourth channel (fourth channel)
134s damming portion
134e radially outside end portion
135 fifth groove
135a load-side second channel (second channel)
135e radially inside end portion
136 sixth groove
136a opposite-to-load-side fourth channel (fourth channel)
136e radially inside end portion
137 branch channel
140 stator
141 stator coil
150, 151, 152 bearing
154 oil pan
200 speed reducer
201 driving gear
202 driven gear
203 driven gear shaft
204, 205 bearing

1. A rotating electrical machine comprising:
a rotor having a magnet disposed in a rotor core; and
a stator disposed radially outside of the rotor,
wherein the rotor is provided with a rotor shaft on an inner circumferential side of the rotor, and the rotor shaft is provided with, within the rotor shaft, a shaft channel through which a coolant flows,
the rotor includes:
a first channel extending outside of the rotor shaft in a radial direction, and having a first discharge port opening radially outward; and
a second channel extending outside of the rotor shaft in the radial direction, extending along an axial direction inside the rotor core, and then extending outward in the radial direction, and having a second discharge port opening radially outward,
the first channel and the second channel are connected to the shaft channel, and
the second discharge port is disposed outside from the first discharge port in the radial direction.

2. The rotating electrical machine according to claim 1, wherein a plurality of the first channels and a plurality of the second channels are provided respectively at equal intervals in a circumferential direction.

3. The rotating electrical machine according to claim 1, a number of the first channel and a number of the second channel are identical.

4. The rotating electrical machine according to claim 1, wherein
the rotor includes:
a third channel extending outward of the rotor shaft in the radial direction, and having a third discharge port opening radially outward; and
a fourth channel extending along the axial direction inside the rotor core, and then extending outward in the radial direction, and having a fourth discharge port opening radially outward,
the third channel and the fourth channel are connected to the shaft channel,
the fourth discharge port is disposed outside from the third discharge port in the radial direction, and
a connecting portion of the first channel and a connecting portion of the second channel with the shaft channel are located on one side of the rotor shaft, and a connecting portion of the third channel and a connecting portion of the fourth channel with the shaft channel are located on another side of the rotor shaft.

5. The rotating electrical machine according to claim 4, wherein a flow direction of the second channel along the axial direction and a flow direction of the fourth channel along the axial direction are opposing to each other.

6. The rotating electrical machine according to claim 1, wherein the second channel is disposed so as to maintain one of magnetic pole symmetry and magnetic pole pair symmetry.

7. The rotating electrical machine according to claim 1, wherein the second channel is disposed so as to maintain none of magnetic pole symmetry and magnetic pole pair symmetry.

8. The rotating electrical machine according to claim 1, wherein the first channel and the second channel each independently communicate with the shaft channel.

9. The rotating electrical machine according to claim 1, wherein the first channel and the second channel share a connection portion to the shaft channel.

10. The rotating electrical machine according to claim 1, wherein the second channel has an upstream-side cross-sectional channel area equal to or larger than a downstream-side cross-sectional channel area.

11. The rotating electrical machine according to claim 1, wherein a cross-sectional channel area of the first channel is equal to or larger than a cross-sectional channel area of the second channel.

12. The rotating electrical machine according to claim 1, wherein
the rotor shaft includes a first shaft channel hole communicating with the first channel and a second shaft channel hole communicating with the second channel, and
a cross-sectional area of the first shaft channel hole is equal to or smaller than a cross-sectional area of the second shaft channel hole.

13. The rotating electrical machine according to claim 1, further comprising:
a first end plate disposed outside of the rotor core on one side in the axial direction; and
a second end plate disposed outside of the first end plate on one side in the axial direction,
wherein a part of the first channel and a part of the second channel are defined by being sandwiched respectively between the first end plate and the second end plate, and between the first end plate and the rotor core.

14. The rotating electrical machine according to claim 1, wherein the rotor shaft has an opening at one end, and another end of the rotor shaft is solid, in the axial direction.

15. The rotating electrical machine according to claim 14, wherein the opening at the one end of the rotor shaft is connected to a coolant pump.

16. A vehicle driving device that drives a vehicle, the vehicle driving device comprising the rotating electrical machine according to claim 1.
